(19) United States
(12) Patent Application Publication
(10) Pub. No.: US 2008/0115356 A1
(43) Pub. Date: May 22, 2008

(54) Cable preform tool

(76) Inventor: Karl J. Peterson, Saint Paul, MN (US)

Correspondence Address: MERCHANT & GOULD PC, P.O. BOX 2903, MINNEAPOLIS, MN, 55402-0903, US

(21) Appl. No.: 11/601,375

(22) Filed: Nov. 17, 2006

(51) Int. Cl. H01R 43/28; H01R 43/22

(52) U.S. Cl. 29/857; 140/117; 29/867; 81/488

(57) ABSTRACT

A tool that is used to correctly measure the proper termination length of the exposed twisted conductor pairs of a cable for insertion into a telecommunications plug and to correctly preform the positional arrangement of the individual conductors for insertion into the plug in a single step is disclosed. A method of terminating an end of a stripped twisted conductor pair cable to a telecommunications plug having a plurality of conductor receiving channels using such a tool is also disclosed.

### TECHNICAL FIELD

The principles disclosed herein relate generally to telecommunications devices. Specifically, the principles disclosed herein relate to tools used in assisting termination of cabling to plugs.

### BACKGROUND

For certain types of telecommunications plugs, current plug assembly processes require personnel to manually perform “wire prep” prior to termination of cables into plugs. One such plug is a category 5E plug such as an RJ45 connector. “Wire prep” is defined as preforming or orienting the leads of each twisted pair of conductors in a cable into their corresponding 568A/568B locations prior to insertion into the plug. Problems may arise when the leads are misaligned, complicating plug insertion. The leads have to be manually adjusted until proper alignment is obtained. Manual “wire prep” can, thus, be cumbersome and also result in a lot of scrapped plugs that fail transmission tests due to improper termination. What is needed in the art is a tool that assists in “wire prep” during termination. What is needed is a tool for achieving repeatability of the “wire prep” process. What is needed is a tool that assists in correctly measuring the termination length for the leads and that preforms all of the twisted pairs in the correct orientation for insertion into a plug.

### SUMMARY

The present disclosure relates to a tool for assisting in correctly measuring the proper plug termination length for the twisted pair wire leads and that assists in correctly orienting and preforming the twisted pair wire leads for insertion into the plug.

In one particular aspect, the disclosure relates to a tool that is used to correctly measure the proper termination length for the leads and to correctly preform the orientation of the leads for insertion into a plug in a single step. An example method of cable termination using such a tool is also described herein.

### BRIEF DESCRIPTION OF THE DRAWINGS

Certain embodiments of present disclosure will now be described, by way of examples, with reference to the accompanying drawings, in which:

FIG. 1 is a front perspective view of a cable preform tool having features that are examples of inventive aspects in accordance with the principles of the present disclosure;

FIG. 2 is a front elevational view of the cable preform tool of FIG. 1;

FIG. 3 is a rear elevational view of the cable preform tool of FIG. 1;

FIG. 4 is a right side elevational view of the cable preform tool of FIG. 1, the left side elevational view being a mirror image of the right side elevational view of the cable preform tool;

FIG. 5 is a front close-up view of the template structure of the cable preform tool of FIG. 1;

FIG. 6 illustrates a cable in which the cable jacket has been stripped to expose the wire leads to be terminated to a plug;

FIG. 7 illustrates the insertion of the exposed leads of the cable of FIG. 6 into the template structure of the cable preform tool of FIG. 1;

FIG. 8 illustrates the leads of the cable in a spread configuration at the rear face of the cable preform tool of FIG. 1 after the leads have been inserted through the cable preform tool;

FIG. 9 illustrates the cable of FIG. 6 after the portions of the leads protruding out from the rear of the cable preform tool, as shown in FIG. 8, have been severed flush with the rear face of the cable preform tool and the cable removed from the cable preform tool;

FIG. 10 illustrates a perspective view of the prepped cable wire leads of FIG. 9 being inserted into a plug for termination; and

FIG. 11 illustrates the insertion of the prepped cable wire leads into the plug of FIG. 10 from a bottom view.

### DETAILED DESCRIPTION

The present disclosure relates to a cable preform tool that is configured to assist in terminating a cable to a telecommunications plug and a method of using such a tool. As will be discussed in further detail below, the tool is configured to assist in correctly measuring the proper termination length of the exposed wires to be inserted into the plug and in correctly positioning and preforming the conductors of the cable for insertion into conductor receiving channels of the plug.

One example of a telecommunications plug is a category 5E plug such as an RJ45 connector. An RJ45 connector is commonly used for digital transmission over telephone lines. Twisted pair wiring typically dominates the wiring commonly used in facilities having telephone wiring. Twisting the wire pairs cancels out radiated energy from current flowing in one wire by the radiated energy from the same return current that flows from the return wire of the same pair. Thus, crosstalk is minimized between adjacent pairs of wire.

As is known in the art, when terminating a cable, such as a UTP cable, to a category 5E plug such as an RJ45 connector, the twisted conductor pairs are untwisted and individual wires are inserted directly into conductor receiving channels, into their corresponding 568A/568B locations. Once the insertion has taken place, the individual wires are crimped down with insulation piercing conductive blades at the front end of the plug. Example RJ45 configurations and further details relating thereto are described to a further extent in U.S. Pat. Nos. 6,311,392; 6,161,278; 5,899,770; and 5,888,100, the entire disclosures of which are hereby incorporated by reference.

During the termination process, it is important to insert the correct conductors into the correct channels of the RJ45 connector. Certain UTP cables that carry four twisted wire pairs may use a color scheme (e.g., a solid and striped color scheme) on the insulation surrounding the individual wires to assist in the termination. For example, in certain wire groups, the insulation surrounding the individual wires may comprise a color scheme consisting of the colors solid orange, striped orange/white, solid blue, striped blue/white, solid green, striped green/white, solid brown, and striped brown/white. However, no matter how experienced the wire handlers may be, the “wire prep” step prior to insertion and the insertion step in terminating the individual wires to their proper locations (e.g., 568A/56B, etc.) may be quite cumbersome. Repeatability, as well as, a reduction in scrap and assembly time, is needed.

The tool and the method having examples of inventive aspects according to the present disclosure provides an efficient way to insert untwisted wires of, for example, a UTP cable, to a telecommunications plug, such as a category 5E plug such as an RJ45 connector.

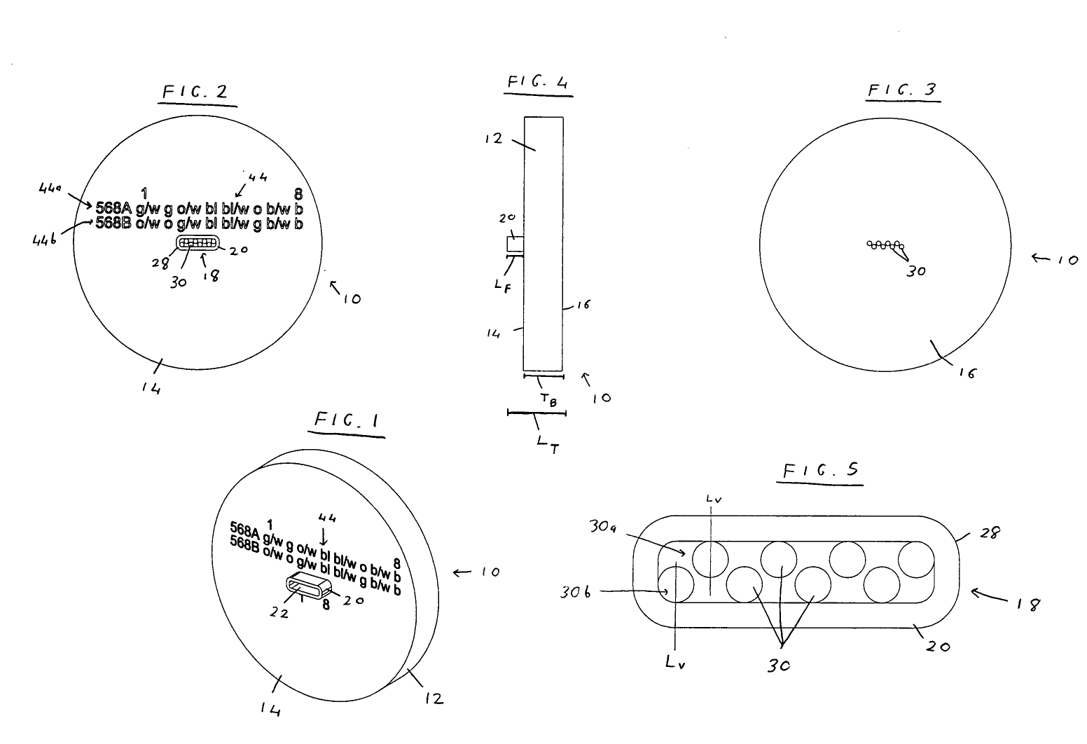

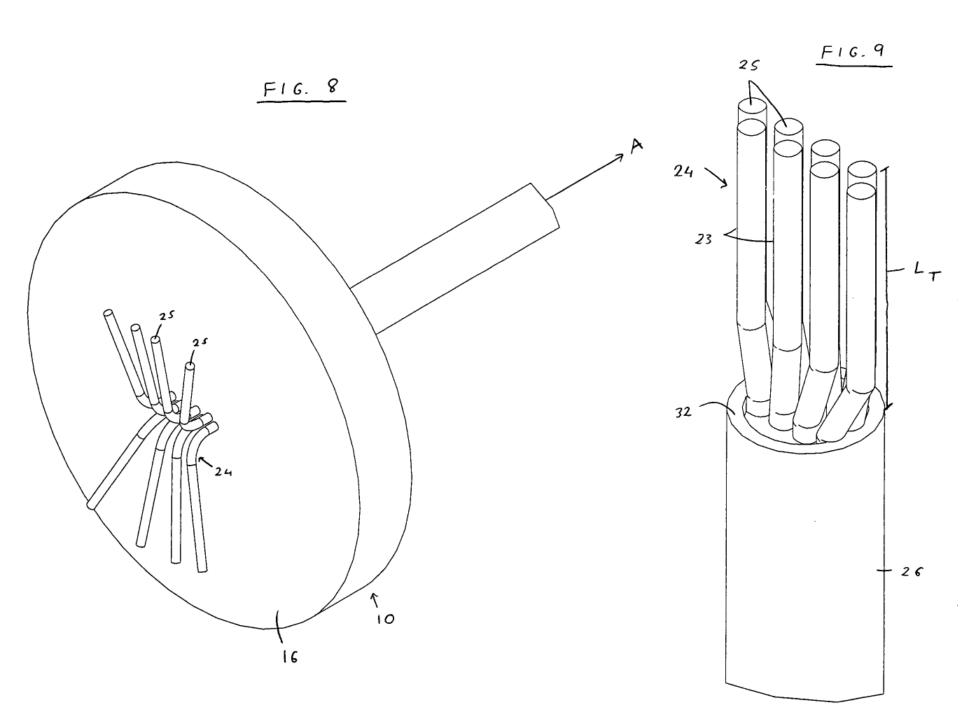

Referring to FIGS. 1-5, a cable preform tool 10 having features that are examples of inventive aspects in accordance with the principles of the present disclosure is illustrated. In the depicted embodiment, the cable preform tool 10 includes a body 12 with a front face 14 and a rear face 16 and thickness T_{B} extending from the front face 14 to the rear face 16. The tool 10 includes a template structure 18. The template structure 18 includes a flange 20 extending out longitudinally away from the front face 14. The flange 20 defines a main opening 22 for receiving exposed wires 24 of a cable 26 (see FIGS. 7-11) that has been stripped. The flange 20 also defines a radial perimeter 28 surrounding the main opening 22.

The body 12 defines a plurality of openings 30 extending from the front face 14 to the rear face 16. In the depicted embodiment of the tool 10, the openings 30 are located generally within the perimeter 28 of the flange 20 and are in communication with the main opening 22. As will be discussed in further detail below, the flange portion 20 of the template structure 18 is configured to abut against a cable jacket 32 at a stripped end 34 of the cable 26 (see FIG. 7) and prevent further insertion thereof into the tool 10 when the exposed wires 24 are being inserted into the plurality of openings 30.

In the depicted embodiment of the tool 10, the template structure 18 is configured with eight openings 30 extending from the front face 14 to the rear face 16. The eight openings 30 correspond to the untwisted individual wires 24 of the four twisted wire pairs of, for example, a UTP cable 26, as discussed above. The eight openings 30 include an upper row of four openings 30a and a lower row of four openings 30b. As shown, the openings 30 are formed in a staggered configuration such that vertical lines L_{V} going through the centerpoint of the upper openings 30a are offset to the right of vertical lines L_{V} going through the centerpoint of the lower openings 30b. This staggered configuration of the openings 30 of the tool 10 shown in the Figures matches the configuration of the conductor receiving channels 36 of an RJ45 connector 38, as discussed above and as shown in FIGS. 10 and 11. In this manner, the conductors 25 of the wires 24 of a UTP cable 26 can be inserted into the openings 30 of the tool 10 and shaped to preform the conductors 25 for easy insertion into the RJ45 connector 38.

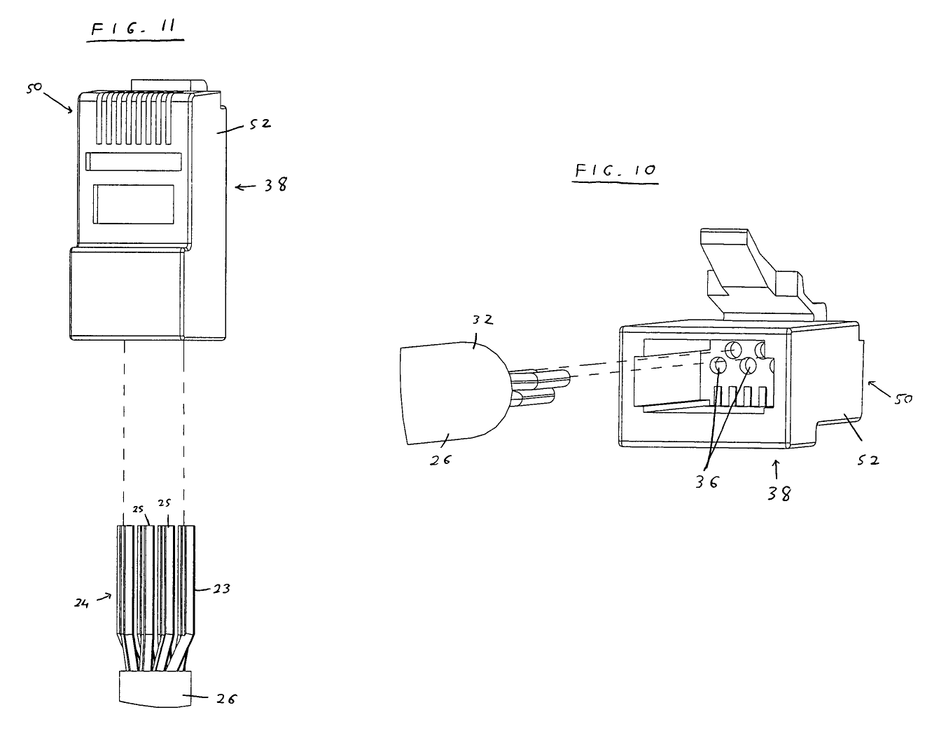

In the depicted embodiment of the tool 10, the flange 20 of the tool 10 is also configured for the RJ45 connector 38. The flange 20 defines a flange length L_{F} extending from an end 40 of the flange 20 to the front face 14 of the tool 10. In certain embodiments, the length L_{F} is about 0.150 inches. In certain embodiments, the body of the tool defines a thickness T_{B} of about 0.500 inches. Together with the flange 20, the tool 10 defines a length L_{T} of 0.650 inches extending from the end 40 of the flange 20 to the second face 16. This length L_{T} is generally equal to a termination length of the conductors 25 for terminating to an RJ45 connector. As used herein, termination length may be defined as the length of exposed conductor to be inserted into a plug after the conductor has been cut to proper length in accordance with the plug type. In this manner, when the individual wires 24 of the cable 26 are inserted into the openings 30 of the tool 10, the flange 20 abuts the cable jacket 32 preventing further insertion thereof. The portions of the conductors 25 protruding out from the rear face 16 can be cut flush with the rear face 16. With this process, the proper termination length can be obtained for the conductors 25, and, when the cable 26 is removed from the tool 10, the conductors 25 will be at the right length for insertion into an RJ45 connector plug. Please see FIG. 9 for a cable 26 having wires 24 that have been prepped and cut.

It should be noted that, as discussed above, an RJ45 connector is simply one example embodiment of a telecommunications plug that the tool 10 can be configured for in assisting in the cable termination. Depending upon the type of plug used, the template structure 18 of the tool 10 can be configured differently, e.g., with different number of wire openings, with different opening patterns, with different flange lengths, with different tool body thicknesses, etc. Although an RJ45 connector is referred to herein to describe the inventive aspects of the tool 10, it should not be used to limit the scope of the invention.

Still referring to FIGS. 1-5, the tool 10 includes indicia 44 on the front face 14. The indicia 44, as depicted, provides a color code guide for matching the colors of the insulation 23 surrounding each of the individual conductors 25 to the proper 568A/568B location openings 30 in the tool 10. In the depicted embodiment, the tool 10 includes indicia 44 for two different wiring schemes (e.g., 568A and 568B), the upper indicia 44a denoting the 568A wiring scheme and the lower indicia 44b denoting the 568B wiring scheme. Referring to FIG. 5, the leftmost lower opening is labeled as opening “1” and the rightmost upper opening is labeled as opening “8”. As noted above, the insulation colors may be comprise orange, orange/white, blue, blue/white, green, green/white, brown, and brown/white. In the depicted embodiment, for 568A locations, for example, the wire with green/white insulation is inserted into the leftmost opening (opening “1”), the wire with green insulation is inserted into the leftmost opening of the upper row, the wire with orange/white insulation is inserted into the second leftmost opening of the lower row, the wire with blue insulation is inserted into the second leftmost opening of the upper row, the wire with blue/white insulation is inserted into the second opening from the right at the lower row, the wire with orange insulation is inserted into the second opening from the right of the upper row, the wire with blue/white insulation is inserted into the rightmost opening of the lower row, and the wire with blue insulation is inserted into the rightmost opening of the upper row (opening “8”). A similar process can be used for the 568B wiring. It will be understood that although the indicia 44 on the tool 10 indicates two different wiring schemes for the wires 24 (568A and 568B schemes), other wiring schemes commonly known in the industry can also certainly be indicated on the face 14 of the tool 10.

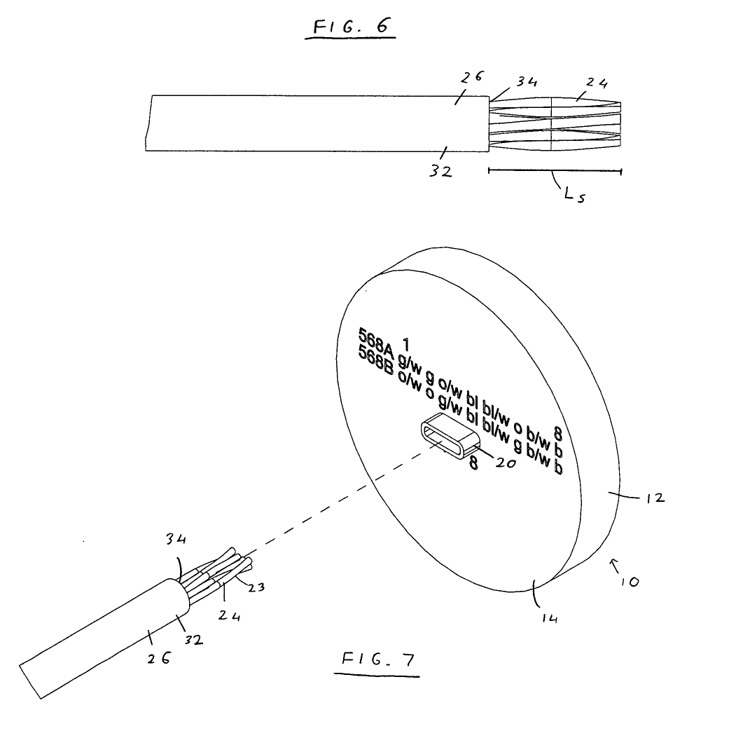

Now referring to FIGS. 6-11, one example method of using the tool 10 is described. First, a portion of the cable jacket 32 is stripped to expose the plurality of twisted wire pairs 24 (see FIG. 6). In one embodiment, the cable jacket 32 may be stripped a length L_{S} of about 1 inch, as shown in FIG. 6. If the cable includes a separator (not shown) separating the twisted pairs, the separator should also be cut. Next, each of the twisted wire pairs are untwisted (using, for example, needle nose pliers, etc.) to separate the individual wires 24. The individual wires 24 are, then, inserted into the main opening 22 defined by the flange 20 and into the plurality of openings 30 defined by the body 12 of the tool 10, following the wiring scheme indicated by the indicia 44. After all of the wires 24 have been inserted into the openings 30, the cable 26 is pushed into the tool 10 until the cable jacket 32 abuts against the flange 20 to prevent further insertion thereof (see FIG. 7). Portions of the individual wires 24 that protrude out from the rear face 16 of the tool body 12 are spread out away from a longitudinal axis A of the cable 26 to yield the conductors 25 into their respective positions (see FIG. 8). Next, the portion of the individual conductors 25 that protrude out from the rear face 16 of the tool 10 are cut flush with the rear face 16 of the tool 10, automatically providing the correct termination length for the conductors 25 as discussed above.

After the individual conductors 25 have been cut flush with the rear face 16 of the tool 10, the cable 26 is pulled away from the tool 10 and the individual wires 24 are removed from the openings 30. A cable 26 that has been prepped with the tool 10 is shown in FIG. 9. As shown in FIG. 9, after the wires 24 have been removed from the tool 10, the wires 24 will generally stay in the same configuration as they were inside the tool 10. The spreading out of the conductors 25 of the wires 24 against the rear face 16 of the tool 10 helps yield the conductors 25 and keep them in the template configuration. In the next step, the individual wires 24 of the cable 26 are inserted into their corresponding conductor receiving channels 36 of the telecommunications plug 38, as shown in FIGS. 10 and 11. When inserting the preformed wires 24 into the plug 38, it may help to manually apply slight pressure on the wires 24 and hold the wires 24 at a slight angle during insertion. This will help guide the wires 24 into place. Once the insertion is complete, as discussed above, the wires 24 will be crimped in place. Conductive blades (not shown) at the front 50 of the plug housing 52 pierce through the insulation 23 of each of the wires 24 and make electrical contact with the conductors 25, as known in the art.

The embodiments discussed above are provided as examples. Having described the preferred aspects and embodiments of the present disclosure, modifications and equivalents of the disclosed concepts may readily occur to one skilled in the art. However, it is intended that such modifications and equivalents be included within the scope of the claims which are appended hereto.

1. A method of terminating an end of a cable having a jacket and a plurality of twisted conductor pairs to a telecommunications plug having a plurality of conductor receiving channels that are in a prearranged configuration, the method comprising:
stripping a portion of the cable jacket to expose the plurality of twisted conductor pairs;
untwisting individual conductors of each of the twisted conductor pairs;
providing a tool including a first side, a second side, a plurality of openings extending from the first side to the second side, the openings on the tool being arranged in a configuration similar to the configuration of the conductor receiving channels of the plug;
inserting the individual conductors into the openings of the tool in a direction generally extending from the first side to the second side of the tool such that the cable jacket generally abuts against the first side of the tool to prevent further insertion of the individual conductors and a portion of each of the individual conductors protrude out from a second side of the tool;
cutting the portion of the individual conductors that protrude out from the second side of the tool flush with the second side of the tool;
after the individual conductors have been cut flush with the second side of the tool, removing the individual conductors of the cable from the openings;
inserting the individual conductors of the cable into conductor receiving channels of the telecommunications plug.

2. A method according to claim 1, further comprising the step of spreading out the protruding portions of the individual conductors away from a longitudinal axis of the cable before cutting the protruding portions flush with the second side of the tool.

3. A method according to claim 1, wherein each of the individual conductors includes an insulation layer surrounding the conductors.

4. A method according to claim 3, wherein the insulation layers of the individual conductors are color coded.

5. A method according to claim 4, wherein the insulation layers of the individual conductors include colors chosen from a group consisting of green, white, orange, and blue.

6. A method according to claim 4, wherein the preform tool includes indicia on at least one of the first face and the second face for indicating the insertion position of each of the individual conductors based on the color coding of the insulation layers.

7. A method according to claim 3, further comprising the step of crimping the individual conductors within a housing of the plug by piercing the insulation of the individual conductors with conductive blades of the plug to make electrical contact with the individual conductors.

8. A method according to claim 1, wherein the cable jacket stripping step includes stripping about a 1-inch portion of the cable jacket to expose the twisted conductor pairs.

9. A method according to claim 8, wherein the tool defines a longitudinal length extending from the first side to the second side, the length being generally equal to the exposed conductor termination length after the protruding portions of the individual conductors have been cut.

10. A method according to claim 8, wherein the longitudinal length of the tool is about 0.650 inches.

11. A method according to claim 1, wherein the cable includes four twisted conductor pairs for a total of eight individual conductors.

12. A method according to claim 1, wherein the plurality of openings of the tool include a first row of openings and a second row of openings, wherein the first row of openings are positioned above the second row of openings and the openings in the first row include first vertical lines going through the centerpoint of the openings, the openings in the second row include second vertical lines going through the centerpoint of the openings, all of the first vertical lines being offset to the left or to the right of all of the second vertical lines.

13. A method according to claim 1, wherein the telecommunications plug is an RJ45 connector.

14. A tool for preparing individual conductors of a multi twisted conductor pair cable having a stripped jacket end for termination to a telecommunications plug having a plurality of conductor receiving channels that are in a prearranged configuration, the tool comprising:
(a) a first side;
(b) a second side; and
(c) a template structure, the template structure comprising:
(i) a plurality of openings extending in a direction from the first side to the second side, each opening being for receiving individual conductors of the multi twisted conductor pair cable, the openings being in a similar positional arrangement to that of the conductor receiving channels of the telecommunications plug; and
(ii) a flange for abutting the stripped cable jacket end to prevent further insertion thereof when the individual conductors are inserted into the plurality of openings, the flange defining a radial perimeter and the plurality of openings being located within the radial perimeter, the tool defining a length extending from the abutting end of the flange to the second side of the tool, the length being generally equal to a termination length of the individual conductors, wherein the termination length is defined by the length of exposed conductor to be inserted into the channels of the plug after the individual conductors have been cut to the proper length.

15. A tool according to claim 14, further including indicia for orienting the individual conductors of the twisted conductor pairs in the correct orientation for insertion into the openings.

16. A tool according to claim 14, wherein the plurality of openings includes eight openings.

17. A tool according to claim 14, wherein the plurality of openings includes a first row of openings and a second row of openings, wherein the first row of openings are positioned above the second row of openings and the openings in the first row include first vertical lines going through the centerpoint of the openings, the openings in the second row include second vertical lines going through the centerpoint of the openings, all of the first vertical lines being offset to the left or to the right of all of the second vertical lines.

18. A method of terminating an end of a cable having a jacket and a plurality of twisted conductor pairs to a telecommunications plug having a plurality of conductor receiving channels that are in a prearranged configuration, the method comprising:
inserting individual conductors of the twisted conductor pairs of the cable into openings in a tool to arrange the individual conductors in a similar configuration as the conductor receiving channels of the plug, wherein, by inserting the individual conductors of the cable into the tool, a termination length of the individual conductors to be cut is automatically determined by a length of the tool in a single step, the termination length being defined as the length of exposed conductor to be inserted into the channels of the plug after the individual conductors have been cut to the proper length.

19. A method according to claim 18, wherein the tool includes indicia for indicating the insertion position of each of the individual conductors based on color coding of insulation surrounding the individual conductors.

20. A method according to claim 18, further comprising the step of crimping the individual conductors within a housing of the plug by piercing an insulation of each of the individual conductors with conductive blades of the plug to make electrical contact with the individual conductors.
